(19) United States
(12) Patent Application Publication
(10) Pub. No.: US 2009/0102546 A1
(43) Pub. Date: Apr. 23, 2009

(54) COMPOSITE BAND-PASS FILTER AND METHOD OF FILTERING QUADRATURE SIGNALS

(76) Inventors: Hiroshi Miyagi, Kanagawa (JP); Scott Tanner, Irvine, CA (US); John Stockman, Corona Del Mar, CA (US); Shiro Fujioko, Fountain Valley, CA (US); Mark Ige, Huntington Beach, CA (US); Jayson Caro, Diamond Bar, CA (US); Anthony Dinh, San Jose, CA (US)

Correspondence Address: CONNOLLY BOVE LODGE & HUTZ LLP, 1875 EYE STREET, N.W., SUITE 1100, WASHINGTON, DC, 20006, US

(21) Appl. No.: 12/293,285

(22) PCT Filed: Mar. 17, 2006
(86) PCT No.: PCT/JP2006/305905

§ 371 Date: Sep. 17, 2008

(51) Int. Cl. H04B 1/68

(52) U.S. Cl. 327/557

(57) ABSTRACT

A composite band-pass filter receives a quadrature input signal and passes an intermediate frequency signal while attenuating all other signals including an undesired image signal. The composite band-pass filter is comprised of a continuous time polyphase filter and a discrete time polyphase filter and can amplify signals. The amplification is distributed through out the composite band-pass filter and the amount of amplification may be selected by control signals. The composite band-pass filter has improved dynamic range and noise characteristics, selectable amplification and replaces an external crystal filter.

### FIELD OF THE INVENTION

This invention relates to polyphase filters, specifically polyphase filters that are used to amplify and selectively attenuate signals in a radio receiver.

### BACKGROUND OF THE INVENTION

The dominant FM receiver architecture is the superhetrodyne radio architecture. FIG. 5 illustrates a typical superhetrodyne radio architecture. In the superhetrodyne architecture, the incoming radio frequency (RF) signal is received by an antenna, amplified by a low noise amplifier (LNA), attenuated by an image filter and then multiplied in the mixer by a signal traditionally called the Local Oscillator (LO). Multiplication in the mixer results in the RF signal being downconverted to a lower intermediate frequency (IF). The IF signal is amplified by an intermediate frequency amplifier (IFA) and is then selectively attenuated by frequency using an external crystal filter. The attenuated signal is then further amplified by an amplifier and is then demodulated. Demodulation converts a frequency modulated signal into an audio signal.

The IF is equal to the frequency difference between the RF signal and LO signal when the RF and LO are mixed together. The mixing function maps two frequencies to the IF. The first frequency is RF-LO. The second frequency is RF+LO. By design, one frequency is the desired RF signal. The other frequency is undesired and is called the image. For example if the IF frequency is 10 MHz and the LO frequency is 100 MHz, then both FR frequencies 110 MHz and 90 MHz will be mapped to the IF frequency. If 110 MHz is the desired RF signal, then 90 MHz is the undesired image.

The undesired image must be attenuated before it is allowed to be added to the desired RF signal. This attenuation has traditionally been done before the mixer (as in FIG. 5). If the attenuation is done after the mixer, then the mixer must be a quadrature mixer. A quadrature mixer maintains both the desired RF signal and the unwanted image separate. If the desired signal and the undesired image become added together, then there is no way to attenuate the undesired image from the desired signal. If the image can be filtered after the mixer then the image filtering requirements before the mixer can be eliminated and combined with other filter and amplifier functions.

After the mixer, an intermediate frequency amplifier (IFA) amplifies the signal and an external crystal filter attenuates all frequencies other than the IF including the undesired image. The resulting signal is then further amplified and then demodulated.

The IF signal can be quite small and so it often needs a significant amount of amplification. Amplifiers with a large amount of gain are typically made up of several amplifiers in series. Noise from the first amplifier needs to be minimized since any noise will be multiplied by the gain of the subsequent amplifiers and will limit the dynamic range of the amplifier.

In some cases the image may be much larger than the desired RF signal. If the large image signal is not adequately filtered and attenuated before amplification, then the large image signal after gain could become large enough to saturate the filter and cause the receiver to stop working. This effect reduces the dynamic range of the receiver. To avoid this condition, it is important to separate and attenuate the undesired image signal before adding gain.

A trend in radio receivers is to incorporate more functions on a single integrated circuit die to reduce the number of external components and total cost. Filtering the IF signal is usually done by an off chip crystal filter. Crystal filters have a very accurate resonate frequency with very little variation. Typically, an external crystal filter with a resonate frequency of 10.7 MHz is used. The intermediate frequency is usually determined by the resonate frequency of the crystal filter. If the external crystal filter is replaced, then the intermediate frequency is no longer restricted by the resonate frequency of the crystal and the intermediate frequency may be reduced. Reducing the intermediate frequency may also save power. In the commercial FM band, architectures with an IF that is significantly less than 10.7 MHz are often referred to as Low Intermediate Frequency architectures.

There have been attempts to replace the external crystal filter with various integrated filters. Some of these filters are polyphase (or complex) filters. Polyphase filters may be continuous or discrete time filters. Both continuous time and discrete time single pole polyphase filters have been developed by others in the past and are not unique. These single pole filters may be cascaded to form filters with arbitrary pole positions.

Continuous time filters have been used to replace the external crystal filter. An example of a continuous time polyphase filter is illustrated by the reference J. Crols, etc, “Low-IF Topologies for High-Performance Analog Front Ends of Fully Integrated Receivers”, IEEE Transactions on Circuits and Systems-II: Analog Digital Signal Processing, Vol. 45, No. 3, pp. 268-282, March 1998. This approach suffers from resistance (R) and capacitor (C) component variation from integrated circuit (IC) to IC when R and C are integrated on the same chip. This R and C variation from IC to IC causes the center frequency of the filter to vary. Typically, R and C may each vary as much as +/−15% from IC to IC yielding a worst case center frequency variation of +/−30% from IC to IC. Additional circuitry is often needed to reduce this center frequency variation. This additional circuitry is complex and requires a periodic calibration routine, which may affect the operation of the receiver. Post manufacture component trimming can also be used to reduce R and C variation. This component trimming is usually too expensive for most commercial applications.

Many polyphase filter approaches have been tried for band-pass filtering the IF. U.S. Pat. Nos. 6,539,066 B1, 6,778,594 B1 and 6,549,066 B1 each have continuous time polyphase filters. These approaches are all susceptible to component variation. U.S. Pat. No. 5,715,529 uses resonators with a complicated feedback. U.S. Pat. No. 4,723,318 has a complicated feedback approach for reducing the effect of component variation. The effect of component variation is reduced for the image filtering or the RF signal filtering but not both. Finally, U.S. Pat. No. 6,236,847 B1 uses two mixers and two extra local oscillators to set the center frequency of the band-pass filter. This approach is unnecessarily complicated.

Switched capacitor filters, which are discrete time filters by their very nature, avoid the problem of R and C component variation. These sampled filter circuits have center frequencies and gains that are set by capacitor ratios, which can be made quite accurate. Switched capacitor filters generally suffer from reduced dynamic range due to inherent switching noise. Subsequent amplification will also amplify any noise and the dynamic range of the receiver will be reduced. An example of a switched capacitor (discrete time) polyphase filter is illustrated by the reference, S. Jantzi, etc, “Quadrature Bandpass ΔS Modulation for Digital Radio”, IEEE Journal of Solid State Circuits, Vol. 32, No. 12, pp. 1935-1950, December 1997.

Discrete time sampled circuits require an anti-aliasing filter in order to attenuate frequencies higher than one half of the sampling frequency. This filter must be a continuous time filter and is usually a low-pass continuous time filter.

Another approach is to use a combination of passive polyphase filters and amplifiers. This approach is illustrated by the reference Behbahani, etc., “CMOS Mixers and Polyphase Filters for Large Image Rejection,” IEEE J. Solid-State Circuits, vol. 36, pp. 873-886, June 2001. In the s-plane, passive polyphase filters have a zero at a negative frequency on the imaginary axis and a pole at a negative frequency on the real axis. This approach has the disadvantage of adding zeros to the transfer function and poles on the real axis. The selectivity of this approach is poor since the pole is on the real axis and not at the desired IF. The undesired image is attenuated, but signals adjacent to the IF are not attenuated. This approach is not efficient since gain cannot be added to the desired signal while attenuating all other signals. Also the additional gain at DC must be removed by subsequent processing or else the dynamic range will be reduced.

What is needed is a band-pass filter that can be integrated on to a chip to replace the external crystal filter and reduce overall cost. This band-pass filter should also be able to attenuate the image created by the mixer. This band-pass filter must be relatively insensitive to component variation and also be able to attenuate any large image signals in such a way as to avoid saturating the filter and limiting the dynamic range of the filter.

Additionally, this band-pass filter should be capable of amplifying signals in a controlled manner. This band-pass filter with amplifying capability should also be very low noise with as much gain in the first amplifier as possible since any internal noise will be amplified by subsequent amplification.

### SUMMARY OF THE INVENTION

Several objects and advantages of the present invention are:
(a) to provide a filter that is easily integrated on to an integrated circuit and will eliminate the need for an external crystal filter,
(b) to provide a filter that does not need calibration,
(c) to provide a filter that can amplify signals and eliminate the need for a separate amplifier,
(d) to provide a filter with improved noise characteristics,
(e) to provide a filter with improved dynamic range,
(f) to provide a filter with selectable signal amplification,
(g) to provide a filter with amplification that may be easily modified to add more selectivity, and
(h) to provide an IF filter with image attenuation comprised of a continuous time active polyphase band-pass filter with programmable gain followed by a switched capacitor polyphase band-pass filter with programmable gain.

In accordance with the present invention, a continuous time polyphase filter followed by a discrete time polyphase filter provide superior signal filtering and amplification to a received radio signal.

### BRIEF DESCRIPTION OF THE DRAWINGS

FIG. 1 Schematic drawing of the composite band-pass filter used in a radio receiver

FIG. 2 Prior art schematic drawing of the BPF1 continuous time polyphase filter

FIG. 3A Prior art schematic drawing of the S/H

FIG. 3B Prior art schematic drawing of the BPF2 discrete time polyphase filter

FIG. 4 drawing of RC-BPF and SC-BPF pole locations in the s-plane

FIG. 5 Prior art schematic drawing of a superhetrodyne receiver architecture with an external crystal filter

### DETAILED DESCRIPTION OF THE PREFERRED EMBODIMENTS

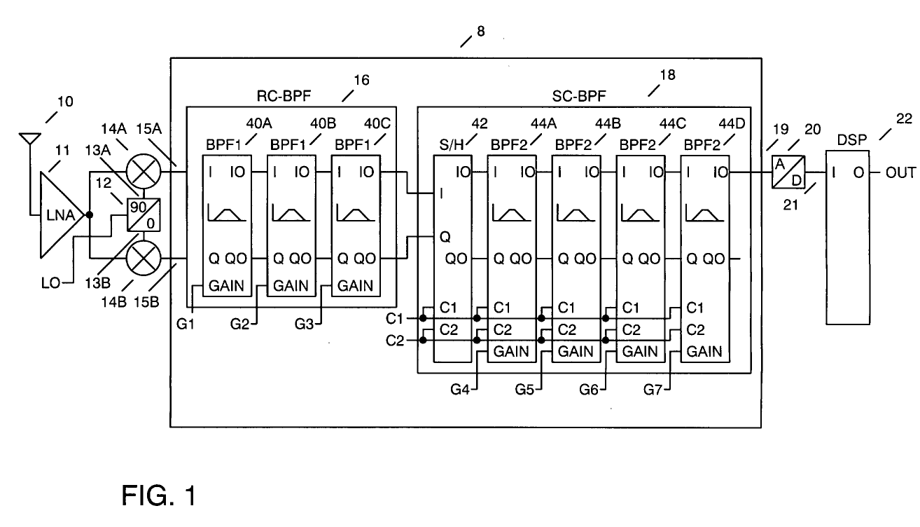

A preferred embodiment of the composite band-pass filter 8 of the present invention is illustrated in FIG. 1 (schematic view). The composite band-pass filter 8 is shown as part of a radio receiver and illustrates just one possible application. This radio receiver has a superhetrodyne architecture. A radio signal is received by an antenna 10. The radio signal is then amplified by a low noise amplifier (LNA) 11 and is then downconverted to a lower frequency by a quadrature mixer 14A and 14B. A quadrature signal generator 12 generates two quadrature signals 13A and 13B from a local oscillator (LO). The two quadrature signals 13A and 13B have a phase difference of 90°. The quadrature mixer 14A and 14B is needed to keep the unwanted image separate from the desired signal. The quadrature mixer 14A and 14B generates two quadrature frequency downconverted signals 15A and 15B. The two quadrature frequency downconverted signals 15A and 15B are then amplified and filtered by the composite band-pass filter 8. In the embodiment shown in FIG. 1, the filtered signal 19 is then converted to a digital signal 21 by an analog to digital converter (A/D) 20. This digital signal 21 is then demodulated and processed by a digital signal processor (DSP) 22. In other embodiments (not shown), the filtered signal remains a sampled analog signal and is demodulated with conventional analog techniques.

Composite band-pass filter 8 is composed of Resistor and Capacitor Band-Pass Filter (RC-BPF) 16 and Switched Capacitor Band-Pass Filter (SC-BPF) 18. RC-BPF 16 is a composite continuous time band-pass filter which is made up of one or more Band-Pass Filter stage 1 (BPF1) 40A. BPF1 40A is a continuous time active polyphase filter. In the preferred embodiment, three BPF1 40A, 40B and 40C are cascaded. The output of BPF1 40A is the input of BPF1 40B. The output of BPF1 40B is the input of BPF1 40C. SC-BPF 18 is a composite discrete time band-pass filter, which is made up of one or more Band-Pass Filter stage 2 (BPF2) 44A. BPF2 44A is a discrete time active polyphase filter. In the preferred embodiment four BPF2 44A, 44B, 44C, and 44D, are cascaded. The output of BPF2 44A is the input of BPF2 44B. The output of BPF2 44B is the input of BPF2 44C. The output of BPF2 44C is the input of BPF2 44D. The number of BPF1 40A in the RC-BPF 16 and the number of BPF2 44A in SC-BPF 18 can be easily varied to change the selectivity of RC-BPF 16, or SC-BPF 18, and thus change the total selectivity of the composite band-pass filter 8.

RC-BPF 16 is a continuous time active polyphase filter. A polyphase filter is an example of a complex filter. Complex filters perform complex operations on signals in the s-plane. Complex operations do not necessarily have a complex conjugate. Freed from the limitation of having a complex conjugate, complex filters are able to perform different operations on positive and negative frequencies and are able to keep the desired signal and the image separate. RC-BPF 16 needs a complex filter to keep the desired signal and the image separate.

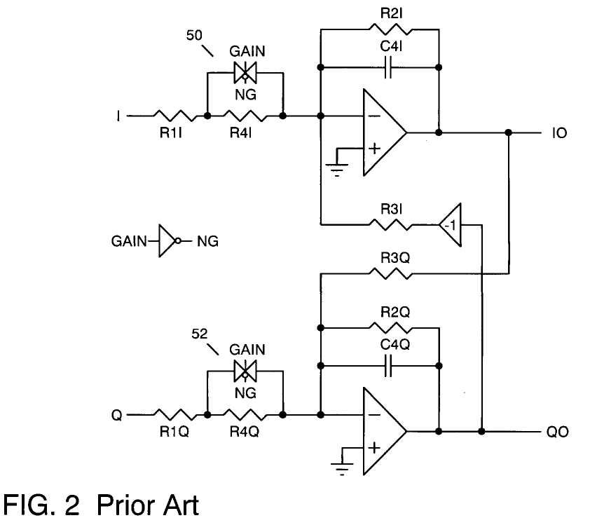

The BPF1 40A, 40B and 40C that make up RC-BPF 16 must also be polyphase. Each BPF1 40A, 40B, and 40C has the same topology but with unique capacitor and resistor sizes. The unique capacitor and resistor sizes determine unique pole locations and affect the transfer function, F(s). The gain of BPF1 40A, 40B, and 40C is controlled by gain control signals G1, G2, and G3. BPF1 40A is illustrated in FIG. 2. BPF1 40A is a typical single ended version of an active polyphase filter. Other embodiments such as a differential version are common.

The transfer function for BPF1 40A is given by

F(s)=[(R1+R4)/R2][1/((s/(R1*C4))+1−j(R1/R3))] where

R1=R1I=R1Q

R2=R2I=R2Q

R3=R3I=R3Q

R4=R4I=R4Q

C4=C4I=C4Q

This transfer function describes a single pole in the s-plane that is offset from the real axis. This single pole does not have a complex conjugate. The position of the pole depends on R1, R3 and C4. With the correct choice of R1, R3 and C4, any pole location can be selected. The gain of F(s) may be changed by changing the resistance of R4. This gain selection is accomplished digitally by shorting the two ends of resistor R4I with transfer gate 50 and the two ends of resistor R4Q with transfer gate 52. The resistance of the transfer gates 50 and 52 when selected is significantly lower than the resistance of R4I or R4Q. The resistance of the transfer gates 50 and 52 when unselected is significantly higher than the resistance of R4I or R4Q. The selection of transfer gates 50 and 52 is controlled by the signal GAIN.

Single BPF1 40A may be cascaded with other BPF1 40A to form filters with many poles. Embodiments with zeros in the transfer function are possible, but are not preferred. RC-BPF 16 is composed of three BPF1 40A, 40B, and 40C. Each BPF1 40A, 40B, or 40C yields a single pole in the s-domain. Three BPF1 40A, 40B, and 40C cascaded together results in a transfer function with 3 poles. So the transfer function of RC-BPP 16 is a transfer function with 3 poles. The resistance and capacitance values for the three BPF1 40A, 40B, and 40C are selected so that 3 poles describe a 3^{rd} order Butterworth band-pass filter in the s-plane. The 3rd order Butterworth band-pass filter is a preferred embodiment. Different filter orders and other filters (such as elliptic) are possible.

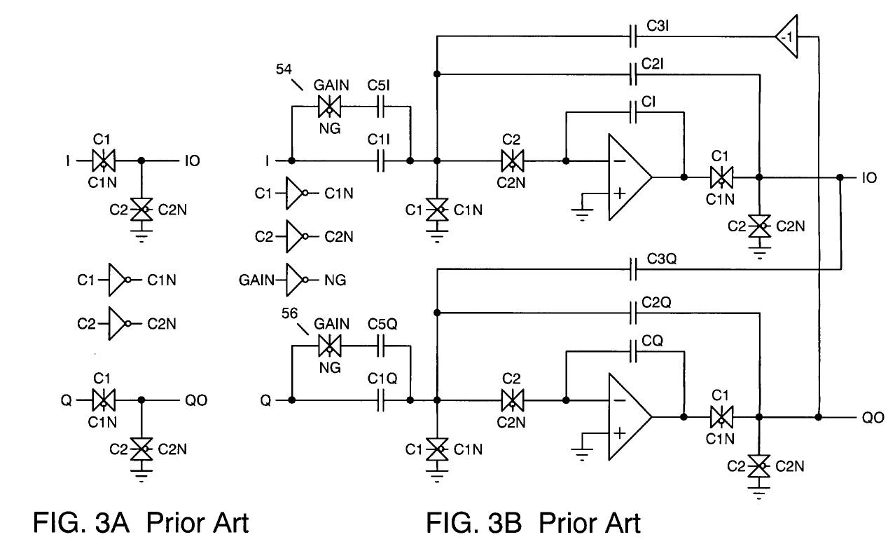

A sample and hold circuit (S/H) 42 is needed to convert the output of RC-BPF 16 from a continuous time signal to a discrete time signal. S/H 42 is illustrated in FIG. 3A. The output of RC-BPF 16 connects to the input of S/H 42. The output of S/H 42 connects to the input of BPF2 44A. S/H 42 is clocked by non-overlapping clocks C1 and C2. SC-BPF 18 is a discrete time complex filter. A complex filter is needed to keep the desired RF signal and the undesired image separate. BPF2 44A, 44B, 44C and 44D that make up SC-BPF, 18 must also be complex filters.

Each BPF2 44A, 44B, 44C and 44D has the same topology with unique capacitor sizes. BPF2 44A is illustrated in FIG. 3B. Other embodiments such as a differential version are also common. BPF2 44A, 44B, 44C and 44D and clocked by non-overlapping clocks C1 and C2. The gain of BPF2 44A, 44B, 44C and 44D is controlled by signals G4, G5, G6, and G7.

The transfer function for BPF2 44A is given by

F(z)=(C1/C)[1/(z−1+(C2/C)−j(C3/C))] where

C=CI=CQ

C1=C1I=C1Q

C2=C2I=C2Q

C3=C3I=C3Q

This equation describes a single pole in the z-plane. This single pole does not have a complex conjugate. The position of the pole depends on C, C2 and C3. With the correct choice of C, C2 and C3, any pole location can be selected. A more general switched capacitor band-pass filter design with zeros added to the transfer function is illustrated in the reference by Janzi, etc. The transfer function of the preferred embodiment uses only poles. The gain of F(z) may be changed by changing the effective capacitance of C5. This change of effective capacitance is accomplished by digitally isolating one side of capacitor C5I with transfer gate 54 and one side of capacitor C5Q with a transfer gate 56. When the transfer gates 54 and 56 are selected, the resistance of the transfer gates 54 and 56 becomes low and capacitors C5Q and C5I become active. When the transfer gates 54 and 56 are deselected, the resistance of the transfer gates 54 and 56 becomes high and capacitors C5Q and C5I are isolated. The selection of transfer gates 54 and 56 is controlled by the signal GAIN.

BPF2 44A may be cascaded with other BPF2 44A to form filters with many poles. SC-BPF 18 is composed of four BPF2 44A, 44B, 44C and 44D to form a four pole band-pass filter. The capacitance values for each BPF2 44A, are selected so that the 4 poles describe a 4^{th} order Butterworth band-pass filter in the z-plane. The 4^{th} order Butterworth band-pass filter is a preferred embodiment. Different filter orders and other filters (such as elliptic) are possible.

A unique feature of the composite band-pass filter 8 is that the RC-BPF 16 functions as an anti-aliasing filter for the SC-BPF 18. Typical existing filter designs have used only continuous time active polyphase filters or have used a discrete time polyphase filter preceded with a low pass continuous time filter as an anti-aliasing filter.

In the preferred embodiment, the three poles of the RC-BPF 16 form a band-pass filter instead of the usual LPF. Additionally, the RC-BPF 16 is comprised of single poles without a conjugate pair. The RC-BPF 16 attenuates the undesired image, provides anti-aliasing for the SC-BPF 18 and produces gain for the desired RF signal. A polyphase (i.e. complex) filter is needed to keep separate the undesired image and provide gain for the desired RF signal. The RC-BPF 16 provides gain and selectivity at the same time so the noise characteristics of the filter are improved over previous designs. The gain of each of the three BPF1 40A, 40B and 40C and on each of the four BPF2 44A, 44B, 44C and 44D is preset to an individual value that can be unique. Each of the three BPF1 40A, 40B and 40C and each of the four BPF2 44A, 44B, 44C and 44D has a gain control line G1, G2, G3, G4, G5, G6 and G7 to change the individual gain to a different value. The total gain of the composite band-pass filter 8 can be varied so that large signals do not saturate the filter and so that small signals can have maximum gain. This gain control allows the desired RF signal to be amplified and the undesired image and the adjacent channels to be attenuated at each BPF1 40A, 40B and 40C, and BPF2 44A, 44B, 44C and 44D so that the dynamic range is improved over previous designs.

The continuous time polyphase filter used in the RC-BPF 16 is sensitive to R and C variation. This R and C variation causes the single poles of BPF1 40A, 40B and 40C to shift in the s-plane and causes the center frequency of RC-BPF 16 to vary. The locations of the single poles of each BPF2 44A, 44B, 44C, or 44D are set by capacitor ratios and do not vary.

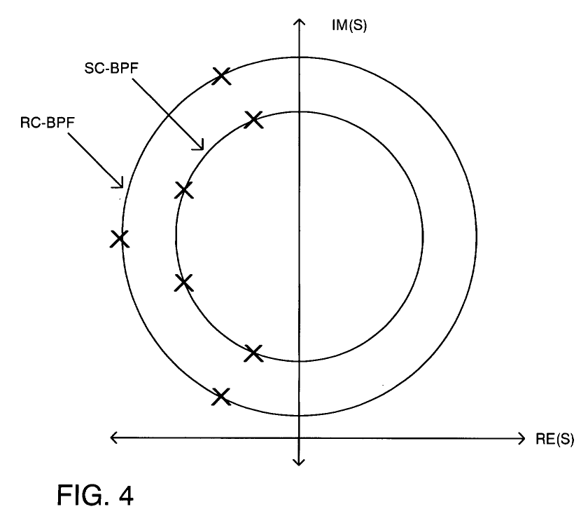

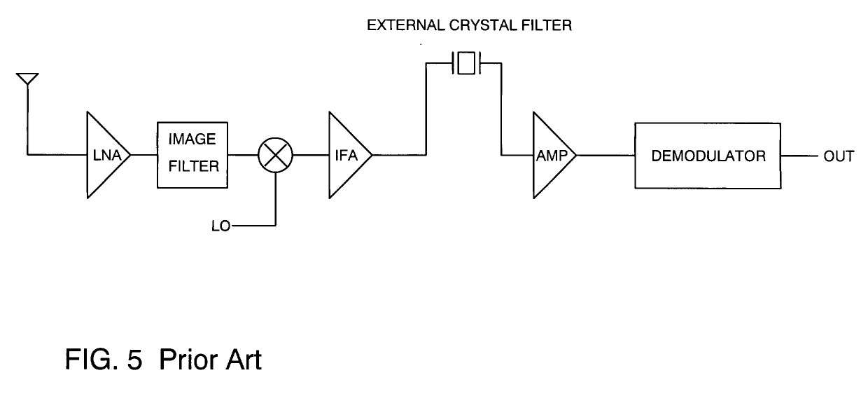

The transfer function of the composite band-pass filter 8 is simply the transfer function of RC-BPF 16 multiplied by the transfer function of SC-BPF 18. The locations of the 3 poles of RC-BPF 16 are chosen to form a 3^{rd} order Butterworth filter. The 4 poles of the SC-PBF 18 are in the z-plane and are derived by the impulse invariant method from 4 poles in the s-plane. The locations of the 4 poles in the s-plane are chosen to form a 4^{th} order Butterworth filter. Butterworth filters have poles located about a circle in the s-plane. These pole locations for the RC-BPF 16 and the SC-BPF 18 are illustrated in FIG. 4.

The 3 poles of RC-BPF 16 are a small part of the total 7 poles of the composite band-pass filter 8. The variation of these 3 poles has less of an effect on the composite band-pass filter 8 than if all 7 poles varied. Additionally, the 3 poles of RC-BPF 16 are placed along a radius that is larger than the radius for the 4 poles of SC-BPF 18. Placing the 3 poles along a larger radius in the s-plane reduces their influence on the center frequency of the composite band-pass filter 8, since as the radius increases, the poles are further away from the center frequency and the bandwidth is wider.

Because 1) the 3 poles of the RC-BPF 16 are a small part of the total of 7 poles in composite band-pass filter 8, and 2) the radius of the 3 poles of RC-BPF 16 are larger in the s-plane than the radius of the 4 poles of SC-BPF 18, the center frequency variation of the composite band-pass filter 8 is low enough that additional circuitry is not needed to minimize the R and C variation. IC to IC center frequency variation is reduced enough that this approach becomes viable whereas a band-pass filter with only continuous time polyphase band-pass filters is not a viable approach without additional circuitry to reduce the R and C variation.

In the preferred embodiment, the transfer function of the RC-BPF 16 and the SC-BPF 18 have only poles and no zeros. Adding zeros to the transfer function of the composite band-pass filter 8 improves attenuation at frequencies near the zero, but degrades attenuation at other frequencies. By not including any zeros in the transfer function of the composite band-pass filter 8 maximum attenuation for all frequencies is attained.

Noise reduction is the main advantage of using RC-BPF 16 and an anti-aliasing filter for SC-BPF 18. Each BPF1 40A, 40B and 40C is a band-pass filter and that removes channel energy associated with the image and with the adjacent channels. Therefore gain can be combined with each BPF1 40A, 40B and 40C without causing saturation. Adding gain and selectivity early in the signal path prior to a switched capacitor filter is important since the first BPF1 40A, determines most of the noise characteristics of the composite filter 8. Using an active polyphase filter as the first BPF1 40A is especially important when the desired signal is small and can be greatly affected by small amounts of noise. An active R and C polyphase filter (as opposed to a passive R and C polyphase filter) is needed to produce a transfer function with a single complex pole. This transfer function with a single complex pole yields a band-pass filter.

A composite band-pass filter 8 or similar structure could also be used for single side band receiver architectures. For a single side band receiver architecture adding zeros to the transfer function of the composite band-pass filter 8 may be beneficial.

Although the description above contains many specificities, these should not be construed as limiting the scope of the invention but as merely providing illustrations of some of the presently preferred embodiments of this invention. For example those skilled in the art will recognize that the preferred embodiment describes a general band-pass filter with quadrature inputs that has applications where a polyphase band-pass filter can be used and is not limited to just radio receivers. Those skilled in the art will also recognize that the preferred embodiments may be manufactured with a standard CMOS process and that equivalent structures often exist for other manufacturing processes such as bipolar.

Thus the scope of the invention should be determined by the appended claims and their legal equivalents, rather than by the examples given.

1. A composite band-pass filter with an input and output comprising:
(a) at least one continuous time polyphase filter with an input and output, the input of the composite band-pass filter being the input of the continuous time polyphase filter,
(b) a sample and hold circuit with an input and output, the input of the sample and hold circuit being the output of the continuous time polyphase filter,
(c) at least one discrete time polyphase filter with an input and output, the input of the discrete time polyphase filter being the output of the sample and hold circuit, the output of the discrete time polyphase filter being the output of the composite band-pass filter.

2. The composite band-pass filter of claim 1, wherein said input of the composite band-pass filter is a quadrature input.

3. The composite band-pass filter of claim 1, wherein said input of sample and hold circuit is a quadrature input.

4. The composite band-pass filter of claim 1, wherein said discrete time polyphase filter is a polyphase switched capacitor filter.

5. The composite band-pass filter of claim 1, wherein said input of discrete time polyphase filter is a quadrature input.

6. The composite band-pass filter of claim 1, wherein said continuous time polyphase filters each have a unique gain.

7. The composite band-pass filter of claim 1, wherein said discrete time polyphase filters each have a unique gain.

8. The composite band-pass filter of claim 1, wherein said continuous time polyphase filters have one or more selectable gains.

9. The composite band-pass filter of claim 1, wherein said discrete time polyphase filters have one or more selectable gains.

10. A method of filtering quadrature signals comprising:
(a) receiving and selectively attenuating by frequency said quadrature signals with one or more continuous time polyphase filters to produce a first output,
(b) sampling said first output signal with a sample and hold circuit to produce a second output, and
(c) receiving and selectively attenuating by frequency said second output with one or more discrete time polyphase filters to produce a third output.

11. The method of filtering quadrature signals of claim 10, wherein said filtering is band-pass filtering.

12. The method of filtering quadrature signals of claim 10, wherein said first output is quadrature.

13. The method of filtering quadrature signals of claim 10, wherein said second output is quadrature.

14. The method of filtering quadrature signals of claim 10, wherein said quadrature signals are amplified by one or more of said continuous time polyphase filters.

15. The method of filtering quadrature signals of claim 10, wherein said second output is amplified by one or more of said discrete time polyphase filters.
